(19) United States
(12) Patent Application Publication
(10) Pub. No.: US 2003/0002903 A1
(43) Pub. Date: Jan. 2, 2003

(54) Keyboard with direction controller

(76) Inventor: Li-Ling Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/892,497

(22) Filed: Jun. 28, 2001

(51) Int. Cl. B41J 5/08

(52) U.S. Cl. 400/480

(57) ABSTRACT

The present invention relates to a keyboard with a direction controller, the direction controller setting on a proper position on the keyboard. In the keyboard, there is a sensor close to the direction controller to detect the direction and movement of the controller and then convert the direction and movement of the controller into the changing of the position of the cursor on the screen. So that, the keyboard has the mouse's operation function on position movement.

### BACKGROUND OF THE INVENTION

1. Field of the Invention

This invention relates to a keyboard with a direction controller, particularly a direction controller that is set to a proper position of the keyboard, to control the movement of the curser.

2. Background of the Invention

Conventional keyboards are an I/O device for used to input data into files. Since windows have been widely used in personal computers, so every computer has had a mouse to control the movement of the curser. There is a kind of mouse with a rolling ball on the bottom. Through moving the mouse deriving a relative movement of the rolling ball, the curse is controlled on the screen. Another one is with a rolling wheel (axle) implemented the center of the mouse. The curse movement is controlled through the rolling wheel.

Obviously, mouse and keyboards are individual devices. In practical operation, it is necessary to move the hand from the keyboard to the mouse, and even to reach the mouse and the curser's position. Therefore, the operation speed will be decreased significantly.

However, most modern keyboard designs focus on multimedia keyboard designs. It means that adding extra keys on the keyboards makes the application on the Internet and MP3 feasible. Nevertheless, nobody has designed a curser controller on a keyboard, so a keyboard with a direction controller has been designed to make the keyboard more practical.

The main objective of the invention is to provide a keyboard with a direction controller setting on a proper position on the keyboard. In the keyboard, there is a sensor close to the direction controller to find the direction of the controller, transfer into the changing of the position of the curser on the screen, and make the keyboard has the mouse's operation function on position movement.

The direction controller could be a rolling axis or a stick device, which can manipulate the movement of curse or screen.

To describe the structure and technology content more detailed, a practical example is listed below illustrating with figures. However, the example listed below is to illustrate the invention, not to restrict it. The replacement or rectification for all the relevant elements still belongs to the scope of this invention.

### BRIEF DESCRIPTION OF DRAWINGS

FIG. 1 is a view of a keyboard with direction controller of the first embodiment of the invention.

FIG. 2 is a view of a keyboard with direction controller of the second embodiment of the invention.

FIG. 3 is a view of a keyboard with direction controller of the third embodiment of the invention.

### DETAILED DESCRIPTION OF THE PRACTICAL IMPLEMENTED EXAMPLE

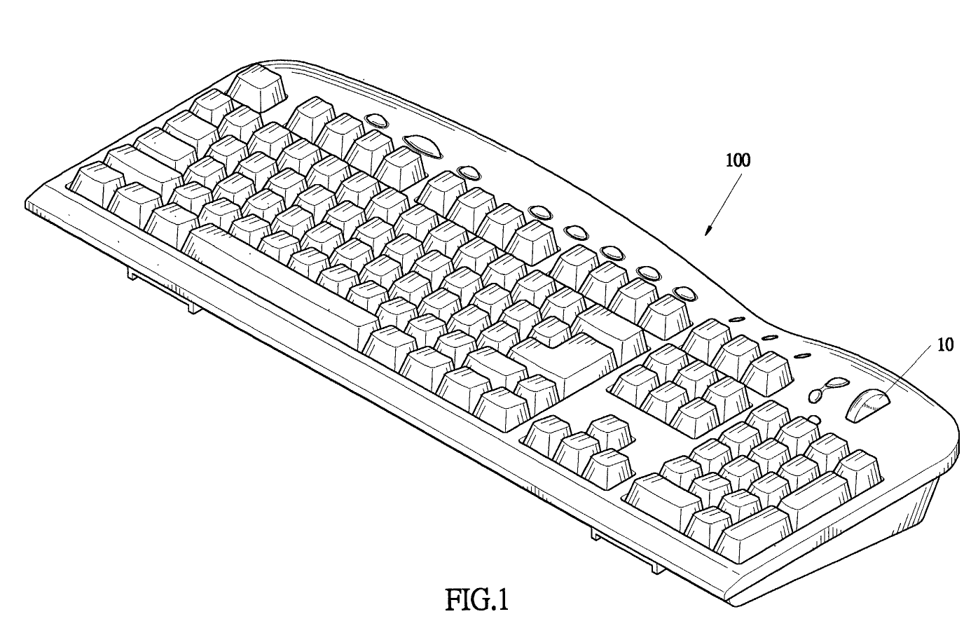

Referring to FIG. 1, the keyboard 100 with direction controller of the invention comprises a direction controller 10, which is located at a proper position of the keyboard 100, such as the top right of the keyboard 100 (as shown in FIG. 1), or up left (not shown), or other proper position. In FIG. 1, the direction controller is a rolling axis. The rolling axis has a shaft through the center of the rolling wheel which makes the rolling wheel can be turned. Within the keyboard, implementing a sensor (not shown in FIG. 1) close to the rolling wheel which can detect the direction and the movement of the rolling wheel. The direction and the movement is converted to the displacement in order to control movement of the cursor. Therefore, the keyboard is combined with the function of the mouse movement.

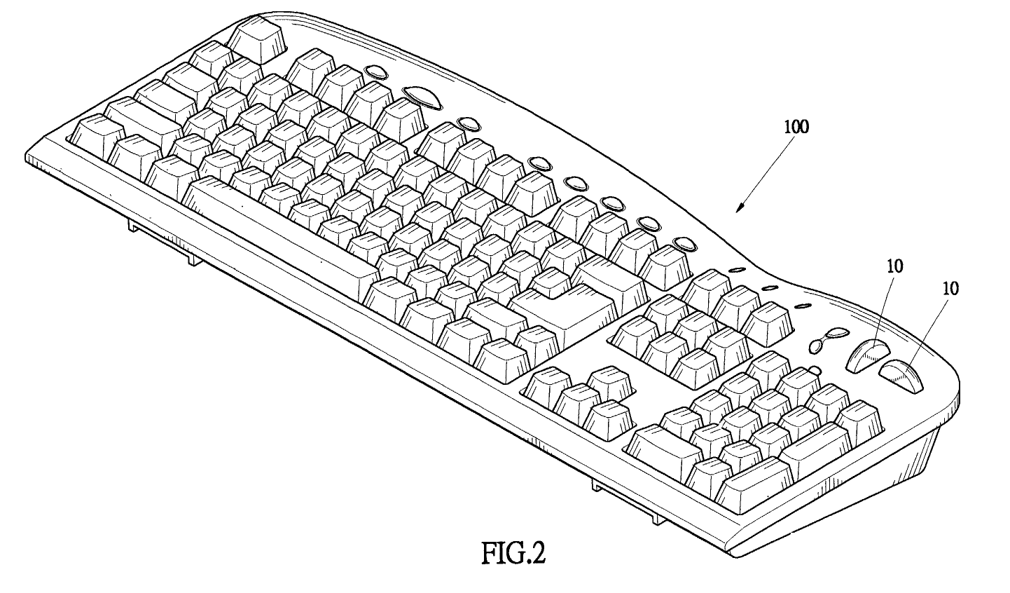

The direction controller 10 of vertical axis (as shown in FIG. 1) can manipulate the vertical movement. In addition, it can also be a horizontal axis to manipulate the horizontal movement (as shown in FIG. 2).

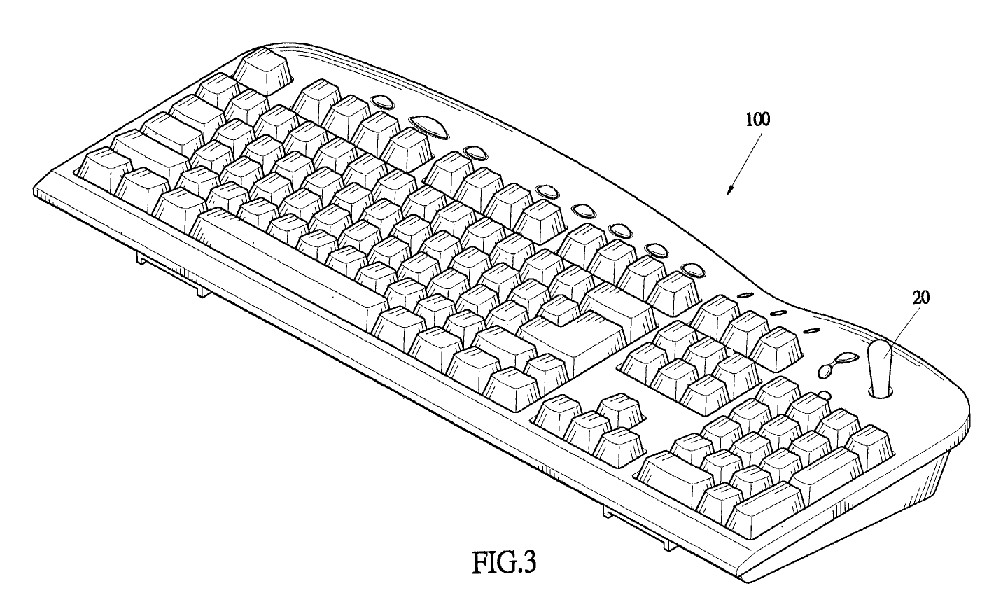

Moreover, in this invention, the direction controller 10 can be a stick-type controller. Referring to FIG. 3, the stick 20 can manipulate the vertical and horizontal movement to drive the curser or screen's movement.

After the direction controller moves to a position, the position can be set by using another control key. And the control key can be designed locating in the positioning-device to act the positioning function.

For the sensor mentioned in the invention and the device and control circuit to convert the direction controller displacement to curser movement are known to people who are familiar with this field, and not the feature of this invention, so no further description will be presented in this specification.

What is claimed is:

1. A keyboard with a direction controller comprising a direction controller located at a proper position of the keyboard, a sensor close to the direction controller to detect the movement of the direction controller and then converting the movement of the direction controller into a displacement value to control the cursor movement on the screen.

2. A keyboard with a direction controller as claimed in claim 1, wherein the direction controller is a rolling axis.

3. A keyboard with a direction controller as claimed in claim 1, wherein the direction controller is a stick.
